(19) United States
(12) Patent Application Publication
(10) Pub. No.: US 2026/0202772 A1
(43) Pub. Date: Jul. 16, 2026

(54) ELECTROPHOTOGRAPHIC PHOTORECEPTOR

(71) Applicant: KYOCERA DOCUMENT SOLUTIONS INC., OSAKA-SHI (JP)

(72) Inventors: HIROKI OTSUKA, OSAKA-SHI (JP); KATSUNORI TERAOKA, OSAKA-SHI (JP); KAZUTAKA SUGIMOTO, OSAKA-SHI (JP)

(21) Appl. No.: 19/448,119

(22) Filed: Jan. 14, 2026

(30) Foreign Application Priority Data
Jan. 15, 2025 (JP) 2025-005673

(51) Int. Cl. G03G 5/147

(52) U.S. Cl. CPC G03G 5/1476

(57) ABSTRACT

An electrophotographic photoreceptor includes: a conductive base, a photosensitive layer provided on the conductive base, and a protective layer provided on the photosensitive layer. The protective layer is a cured body of a photocurable composition that includes a photocurable compound and a photopolymerization initiator. The photopolymerization initiator includes a first compound having an acylphosphine oxide structure and a second compound having an α-aminoacetophenone structure and an absorption coefficient at a wavelength 365 nm smaller than that of the first compound. A total content of the first compound and the second compound with respect to 100 parts by mass of the photocurable compound is 5 parts by mass or more and 20 parts by mass or less.

### CROSS-REFERENCE TO RELATED PATENT APPLICATION

This application claims the benefit of Japanese Priority Patent Application JP 2025-005673 filed on Jan. 15, 2025, the entire contents of which are incorporated herein by reference.

### FIELD OF THE DISCLOSURE

The present disclosure relates to an electrophotographic photoreceptor.

### BACKGROUND OF THE DISCLOSURE

In recent years, technological development have been underway in copiers and image forming apparatuses to increase the operation speed and extend the lifetimes of parts. Photoreceptors used in the copiers and image forming apparatuses are desired to have high wear resistance to withstand repeated processes in order to extend the lifetimes. In this regard, a technology has been known for improving the wear resistance of the photoreceptor by forming a protective layer having a high hardness using a thermosetting resin or a photocurable resin on the surface of the photoreceptor.

### SUMMARY OF THE DISCLOSURE

According to an embodiment of the present disclosure, there is provided an electrophotographic photoreceptor, including: a conductive base; a photosensitive layer provided on the conductive base; and a protective layer provided on the photosensitive layer.

The protective layer is a cured body of a photocurable composition that includes a photocurable compound and a photopolymerization initiator.

The photopolymerization initiator includes a first compound having an acylphosphine oxide structure and a second compound having an α-aminoacetophenone structure and an absorption coefficient at a wavelength 365 nm smaller than that of the first compound.

A total content of the first compound and the second compound with respect to 100 parts by mass of the photocurable compound is 5 parts by mass or more and 20 parts by mass or less.

### BRIEF DESCRIPTION OF THE DRAWINGS

FIG. 1 is a partial cross-sectional view of a single-layer electrophotographic photoreceptor that is an example of an electrophotographic photoreceptor according to an embodiment of the present disclosure.

FIG. 2 is a partial cross-sectional view of a single-layer electrophotographic photoreceptor that is an example of the electrophotographic photoreceptor according to this embodiment.

FIG. 3 is a partial cross-sectional view of a stacked electrophotographic photoreceptor that is an example of the electrophotographic photoreceptor according to this embodiment.

FIG. 4 is a partial cross-sectional view of a stacked electrophotographic photoreceptor that is an example of the electrophotographic photoreceptor according to this embodiment.

FIG. 5 is a partial cross-sectional view of a stacked electrophotographic photoreceptor that is an example of the electrophotographic photoreceptor according to this embodiment.

### DETAILED DESCRIPTION OF THE EXEMPLARY EMBODIMENTS

An embodiment of the present disclosure will be described below in detail. Note that the present disclosure is not limited to the configurations of the following embodiments, and various modifications can be made to the configurations of the following embodiments as appropriate within the technical idea of the present disclosure. Further, in the present specification, the term “-based” is added after the compound name to collectively refer to the compound and derivatives thereof in some cases. Further, in the case of adding the term “-based” after a compound to refer to a polymer name, it means that the repeating unit of the polymer is derived from the compound or a derivative thereof. Further, a “general formula” and a “chemical formula” are collectively referred to as a “formula”. The phrase “each independently” in the description of the formula means that they may indicate the same group or different groups.

### [Overall Configuration of Electrophotographic Photoreceptor]

On the surface of the photoreceptor, a discharge product such as ozone and NOx is generated by electric discharge. In the photoreceptor provided with a protective layer, with repeated processes, the discharge product permeates from the surface of the protective layer into the inside thereof. For this reason, in the protective layer of the photoreceptor, if there is a portion where the curing reaction is insufficient even partially, an unreacted group or an OH group reacts with the discharge product, leading to a decrease in volume resistivity due to an increase in hygroscopicity. Thus, in the photoreceptor provided with a protective layer, a defect such as unintended image flow and bleeding (image deletion) is likely to occur particularly in images formed under a high humidity environment. On the other hand, the present disclosure provides an electrophotographic photoreceptor capable of suppressing the occurrence of image deletion.

In the protective layer of this electrophotographic photoreceptor, the use of predetermined amounts of a first compound and a second compound as a photopolymerization initiator allows the curing reaction of the photocurable compound to sufficiently proceed throughout the entire protective layer. Specifically, a first compound having an acylphosphine oxide structure promotes the curing reaction of the photocurable compound within the protective layer, and a second compound having an α-aminoacetophenone structure and an absorption coefficient at a wavelength 365 nm smaller than that of the first compound promotes the curing reaction of the photocurable compound on the surface of the protective layer. For this reason, in this electrophotographic photoreceptor, since a decrease in volume resistivity due to moisture absorption in the protective layer is less likely to occur, it is possible to suppress the occurrence of image deletion.

An electrophotographic photoreceptor according to an embodiment of the present disclosure can be configured as a single-layer electrophotographic photoreceptor or a stacked electrophotographic photoreceptor. Note that in the following description, the “electrophotographic photoreceptor” will also be referred to simply as a “photoreceptor”, the “single-layer electrophotographic photoreceptor” will also be referred to simply as a “single-layer photoreceptor”, and the “stacked electrophotographic photoreceptor” will also be referred to simply as a “stacked photoreceptor”.

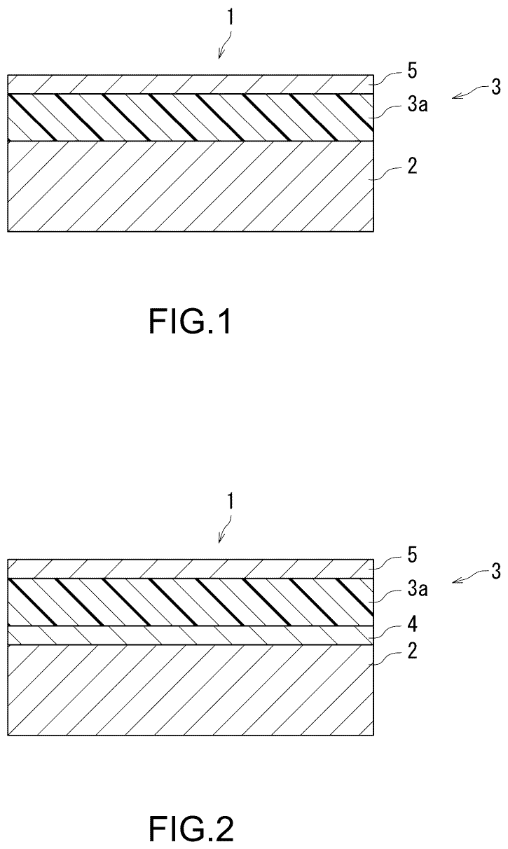

First, a single-layer photoreceptor 1 according to this embodiment will be described. FIG. 1 is a partial cross-sectional view of the single-layer photoreceptor 1. The single-layer photoreceptor 1 includes a conductive base 2, a photosensitive layer 3, and a protective layer 5. The photosensitive layer 3 is of a single-layer type including only a single-layer photosensitive layer 3a. In the single-layer photoreceptor 1, the single-layer photosensitive layer 3a is provided on the conductive base 2, and the protective layer 5 is provided on the single-layer photosensitive layer 3a.

In the single-layer photoreceptor 1, the photosensitive layer 3 may be provided directly on the conductive base 2 as shown in FIG. 1. However, another layer may be provided between the conductive base 2 and the photosensitive layer 3. For example, as shown in FIG. 2, in the single-layer photoreceptor 1, an intermediate layer 4 (undercoat layer 4) may be provided between the conductive base 2 and the photosensitive layer 3.

The protective layer 5 forms the top surface layer of the single-layer photoreceptor 1. In the single-layer photoreceptor 1, the protective layer 5 may be provided directly on the photosensitive layer 3 as shown in FIG. 1. However, another layer may be provided between the photosensitive layer 3 and the protective layer 5. For example, in the single-layer photoreceptor 1, an intermediate protective layer that is not the top surface layer may be provided between the photosensitive layer 3 and the protective layer 5.

In the single-layer photoreceptor 1, the photosensitive layer 3 (single-layer photosensitive layer 3a) favorably has a thickness of 5 μm or more and 100 μm or less, more favorably 10 μm or more and 50 μm or less.

Next, a stacked photoreceptor 10 according to this embodiment will be described. FIG. 3 is a partial cross-sectional view of the stacked photoreceptor 10. The stacked photoreceptor 10 includes the conductive base 2, the photosensitive layer 3, and the protective layer 5. The photosensitive layer 3 is of a stacked type including a charge generating layer 3b and a charge transporting layer 3c. In the stacked photoreceptor 10, the charge generating layer 3b is provided on the conductive base 2, the charge transporting layer 3c is provided on the charge generating layer 3b, and the protective layer 5 is provided on the charge transporting layer 3c.

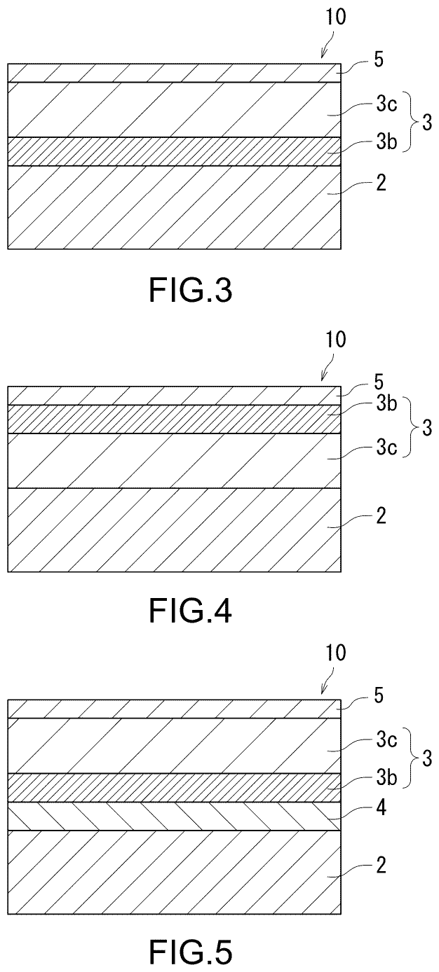

In the stacked photoreceptor 10, the configuration of the photosensitive layer 3 is not limited to the configuration shown in FIG. 3. For example, as shown in FIG. 4, the charge transporting layer 3c may be provided on the conductive base 2, the charge generating layer 3b may be provided on the charge transporting layer 3c, and the protective layer 5 may be provided on the charge generating layer 3b.

Further, in the stacked photoreceptor 10, the photosensitive layer 3 may be provided directly on the conductive base 2 as shown in FIG. 3 and FIG. 4. However, another layer may be provided between the conductive base 2 and the photosensitive layer 3. For example, as shown in FIG. 5, in the single-layer photoreceptor 1, the intermediate layer 4 may be provided between the conductive base 2 and the photosensitive layer 3.

In the stacked photoreceptor 10, the charge generating layer 3b favorably has a thickness of 0.01 μm or more and 5 μm or less, more favorably 0.1 μm or more and 3 μm or less. The charge generating layer 3b does not necessarily need to have a single-layer structure shown in FIGS. 3 to 5, and may have a stacked structure including a plurality of layers.

The protective layer 5 forms the top surface layer of the stacked photoreceptor 10. In the stacked photoreceptor 10, the protective layer 5 may be provided directly on the photosensitive layer 3 as shown in FIGS. 3 to 5. However, another layer may be provided between the photosensitive layer 3 and the protective layer 5. For example, in the stacked photoreceptor 10, an intermediate protective layer that is not the top surface layer may be provided between the photosensitive layer 3 and the protective layer 5.

### [Protective Layer]

In the photoreceptor according to this embodiment, the protective layer forming the top surface layer has a function of improving wear resistance. The protective layer is a photocurable resin that is a cured body formed by curing a photocurable composition including a photocurable compound and a photopolymerization initiator.

The photocurable composition forming the protective layer includes a first compound and a second compound as a photopolymerization initiator. The first compound has an acylphosphine oxide structure. The second compound has an α-aminoacetophenone structure and an absorption coefficient at a wavelength 365 nm smaller than that of the first compound. The use of both the first compound and the second compound as a photopolymerization initiator, it is possible to allow the curing reaction to sufficiently proceed throughout the entire photocurable composition. Specifically, the first compound promotes the curing reaction of the photocurable compound within the protective layer, and the second compound promotes the curing reaction of the photocurable compound on the surface of the protective layer. As a result, in the photoreceptor according to this embodiment, the increased curability across the entire protective layer maintain the low hygroscopicity, and a decrease in volume resistivity in the protective layer is less likely to occur, thereby making it possible to suppress the occurrence of image deletion.

In the photoreceptor according to this embodiment, in order to achieve the effect of suppressing the occurrence of image deletion by the protective layer, the total content of the first compound and the second compound in the photopolymerization initiator with respect to 100 parts by mass of the photocurable compound is set to 5 parts by mass or more and 20 parts by mass or less. By setting the total content of the first compound and the second compound to 5 parts by mass or more, it is possible to achieve high curability across the entire protective layer. By setting the total content of the first compound and the second compound to 20 parts by mass or less, it is possible to suppress the occurrence of image deletion due to the excess photopolymerization initiator.

Further, in the photoreceptor according to this embodiment, the photocurable composition forming the protective layer favorably includes two or more types of monomers or oligomers having an acryloyl group. This allows one photocurable compound to suitably penetrate the voids of the other photocurable compound and these photocurable compounds to be densely arranged, thereby forming a photocurable resin having high curing reactivity.

Further, in the photoreceptor according to this embodiment, the photocurable composition forming the protective layer favorably includes a compound having three or more polymerizable functional groups and a compound having two or less polymerizable functional groups. This allows the compound having two or less polymerizable functional groups to suitably penetrate the voids of the compound having three or more polymerizable functional groups and these compounds to be densely arranged, thereby forming a photocurable resin having high curing reactivity.

In addition, in the photoreceptor according to this embodiment, the protective layer favorably includes an oxygen absorber. In the protective layer including the oxygen absorber, since the action that inhibits the curing reaction by oxygen can be suppressed, the curing reaction easily progresses sufficiently. The content of the oxygen absorber in the protective layer is favorably 0.1 mass % or more and 10 mass % or less. The oxygen absorber favorably includes a compound represented by the following formula (A) in order to more effectively achieve the above effect.

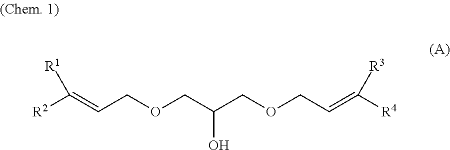

In the formula (A), R¹ to R⁴ each independently represent either one of an alkyl group having 1 to 6 carbon atoms, an alkenyl group having 2 to 6 carbon atoms, and an aralkyl group.

Further, in the photoreceptor according to this embodiment, the protective layer is favorably a cured body formed by curing the photocurable composition by irradiation of ultraviolet light in the atmospheric atmosphere. This allows the protective layer to be formed at low cost. In the protective layer including the oxygen absorber, the effect of the oxygen absorber allows the curing reaction of the photocurable compound to proceed sufficiently even in the atmospheric atmosphere.

In the photocurable composition forming the protective layer, the content of the photocurable compound is favorably 50 mass % or more and 99 mass % or less, more favorably 70 mass % or more and 90 mass % or less.

The protective layer favorably has a thickness of 1 μm or more and 30 μm or less, more favorably 1 μm or more and 4 μm or less, still more favorably 2 μm or more and 4 μm or less. By setting the thickness of the protective layer to 1 μm or more, it is possible to improve the sensitivity characteristics of the photoreceptor. By setting the thickness of the protective layer to 30 μm or less, it is possible to improve the wear resistance of the photoreceptor.

Examples of the first compound having an acylphosphine oxide structure, which constitutes the photopolymerization initiator included in the photocurable composition, include 2,4,6-trimethylbenzoyl-diphenylphosphineoxide, phenylbis(2,4,6-trimethylbenzoyl)phosphineoxide, and lithiumphenyl(2,4,6-trimethylbenzoyl)phosphonate.

Examples of the second compound having an α-aminoacetophenone structure, which constitutes the photopolymerization initiator included in the photocurable composition, include 2-methyl-1-[4-(methylthio)phenyl]-2-morpholinopropane-1-one, 2-benzyl-2-(dimethylamino)-1-(4-morpholinophenyl)-1-butanone, and 2,2′-dihydroxy-2,2′-dimethyl-1,1′-[methylenebis(4,1-phenylene)]bis(propane-1-one).

In the photocurable composition, as the photopolymerization initiator, only the first compound and the second compound may be blended. However, in addition to the first compound and the second compound, a different compound may be blended. Examples of the different compound include a ketal compound, a benzoinether compound, an anthraquinone compound, and a thioxanthone compound.

The protective layer may further include, for example, at least one of a conductive material, a metal oxide, or an additive, as necessary, in addition to the oxygen absorber.

Examples of the metal oxide include alumina, zinc oxide, titanium oxide, and tin oxide. The metal oxide does not necessarily need to be doped. However, in order to increase the conductivity of the protective layer, the metal oxide is favorably doped. Examples of the doped metal oxide include phosphorus-doped tin oxide and antimony-doped tin oxide. As the metal oxide, alumina is favorable. In order to improve the repeated sensitivity characteristics of the photoreceptor, it is favorable that the protective layer does not include at least one of tin oxide, titanium oxide, or zinc oxide.

Examples of the additive included in the protective layer include a leveling agent and a different known additive. As the leveling agent, a leveling agent containing a halogen atom is favorable, an acrylic polymer containing a halogen atom is more favorable, a fluorosilicone modified acrylic polymer is still more favorable, and a UV curable fluorosilicone modified acrylic polymer is particularly favorable. The leveling agent may have a polymerizable functional group. In the case where the leveling agent has a polymerizable functional group, the photocurable resin includes a repeating unit derived from a leveling agent as a repeating unit. In the case where the leveling agent has a polymerizable functional group, the polymerizable functional group equivalent (e.g., the vinyl group equivalent) of the leveling agent is favorably 100 g/mol or more and 500 g/mol or less, more favorably 260 g/mol or more and 450 g/mol or less. Note that it is favorable that the protective layer does not include a charge generating agent, a hole transporting agent, and an electron transporting agent.

### [Photosensitive Layer]

The photosensitive layer includes, for example, a charge generating agent, a hole transporting agent, and a binder resin. In the case where the photoreceptor is a single-layer photoreceptor, the single-layer photosensitive layer that is a photosensitive layer includes a charge generating agent, a hole transporting agent, and a binder resin. The single-layer photosensitive layer favorably further includes an electron transporting agent. The single-layer photosensitive layer may further include an additive, as necessary.

In the case where the photoreceptor is a stacked photoreceptor, the charge generating layer included in the photosensitive layer includes a charge generating agent. The charge transporting layer included in the photosensitive layer includes a hole transporting agent and a binder resin. The charge generating layer may further include a base resin, as necessary. Each of the charge generating layer and the charge transporting layer may further include an additive, as necessary. Each of the charge generating layer and the charge transporting layer may include a radical acceptor compound. However, each of the charge generating layer and the charge transporting layer does not necessarily need to include a radical acceptor compound.

Examples of the charge generating agent include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of an inorganic photoconductive material (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment.

The phthalocyanine pigment has a phthalocyanine structure. Examples of the phthalocyanine pigment include metal phthalocyanine and metal-free phthalocyanine. Examples of the metal phthalocyanine include titanyl phthalocyanine, hydroxygallium phthalocyanine, and chlorogallium phthalocyanine. As the metal phthalocyanine, titanyl phthalocyanine is favorable. The titanyl phthalocyanine is represented by the following formula (CG-1). The metal-free phthalocyanine is represented by the following formula (CG-2).

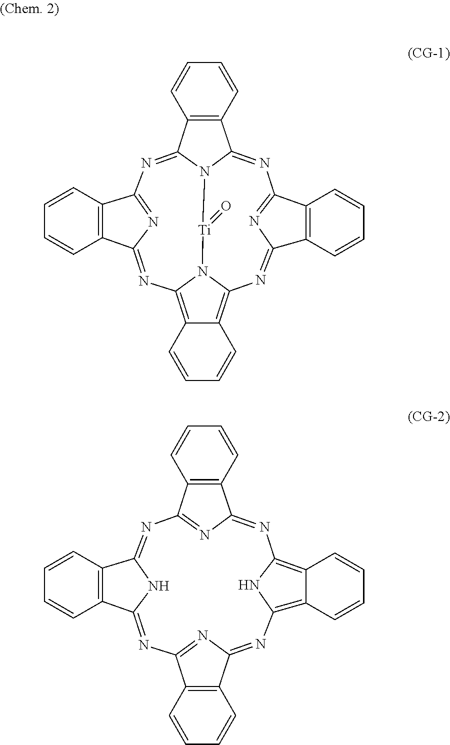

The phthalocyanine pigment may be crystalline or non-crystalline.

Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include α-type, β-type, and Y-type crystals of the titanyl phthalocyanine (hereinafter, respectively referred to as α-type, β-type, and Y-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As the charge generating agent, a phthalocyanine pigment is favorable, titanyl phthalocyanine or metal-free phthalocyanine is more favorable, and Y-type titanyl phthalocyanine or X-type metal-free phthalocyanine is particularly favorable because they have a high quantum yield in the wavelength region of 700 nm or more.

The Y-type titanyl phthalocyanine has a main peak at, for example, 27.2° of the Bragg angle (2θ±0.2°) in the CuKα characteristic X-ray diffraction spectrum. The main peak in the CuKα characteristic X-ray diffraction spectrum is a peak having the first or second highest intensity in the range of the Bragg angle (2θ±0.2°) of 3° or more and 40° or less. The Y-type titanyl phthalocyanine does not have a peak at 26.2° in the CuKα characteristic X-ray diffraction spectrum.

The CuKα characteristic X-ray diffraction spectrum can be measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine) to measure the X-ray diffraction spectrum under the conditions of an X-ray tube Cu, a tube voltage of 40 kV, a tube current of 30 mA, and a wavelength of CuKα characteristic X-rays of 1.542 Å. The measurement range (2θ) is, for example, 3° or more and 40° or less (start angle of 3°, stop angle of 40°), and the scanning speed is, for example, 10°/min. The main peak is determined from the obtained X-ray diffraction spectrum, and the Bragg angle of the main peak is read.

In the case where the photoreceptor is a single-layer photoreceptor, the content of the charge generating agent is favorably 0.1 parts by mass or more and 50 parts by mass or less, more favorably 0.5 parts by mass or more and 30 parts by mass or less, with respect to 100 parts by mass of the binder resin. In the case where the photoreceptor is a stacked photoreceptor, the content of the charge generating agent is favorably 10 parts by mass or more and 300 parts by mass or less, more favorably 100 parts by mass or more and 200 parts by mass or less, with respect to 100 parts by mass of the base resin.

Examples of the hole transporting agent include a triphenylamine derivative, a diamine derivative (e.g., an N,N,N′,N′-tetraphenylbenzidine derivative, an N,N,N′,N′-tetraphenylphenylenediamine derivative, an N,N,N′,N′-tetraphenylnaphthylenediamine derivative, an N,N,N′,N′-tetraphenylphenanthrylenediamine derivative, and a di(aminophenylethenyl)benzene derivative)), an oxadiazole compound (e.g., 2,5-di(4-methylaminophenyl)-1,3,4-oxadiazole), a styryl compound (e.g., 9-(4-diethylaminostyryl)anthracene), a carbazole compound (e.g., polyvinylcarbazole), an organic polysilane compound, a pyrazoline compound (e.g., 1-phenyl-3-(p-dimethylaminophenyl)pyrazoline), a hydrazone compound, an indole compound, an oxazole compound, an isooxazole compound, a thiazole compound, a thiadiazole compound, an imidazole compound, a pyrazole compound, and a triazole compound.

In order to improve the sensitivity characteristics of the photoreceptor, the hole transporting agent favorably includes at least one of compounds represented by the formulae (1), (2), and (3). Hereinafter, the compounds represented by the formulae (1), (2), and (3) will be respectively referred to as hole transporting agents (1), (2), and (3) in some cases.

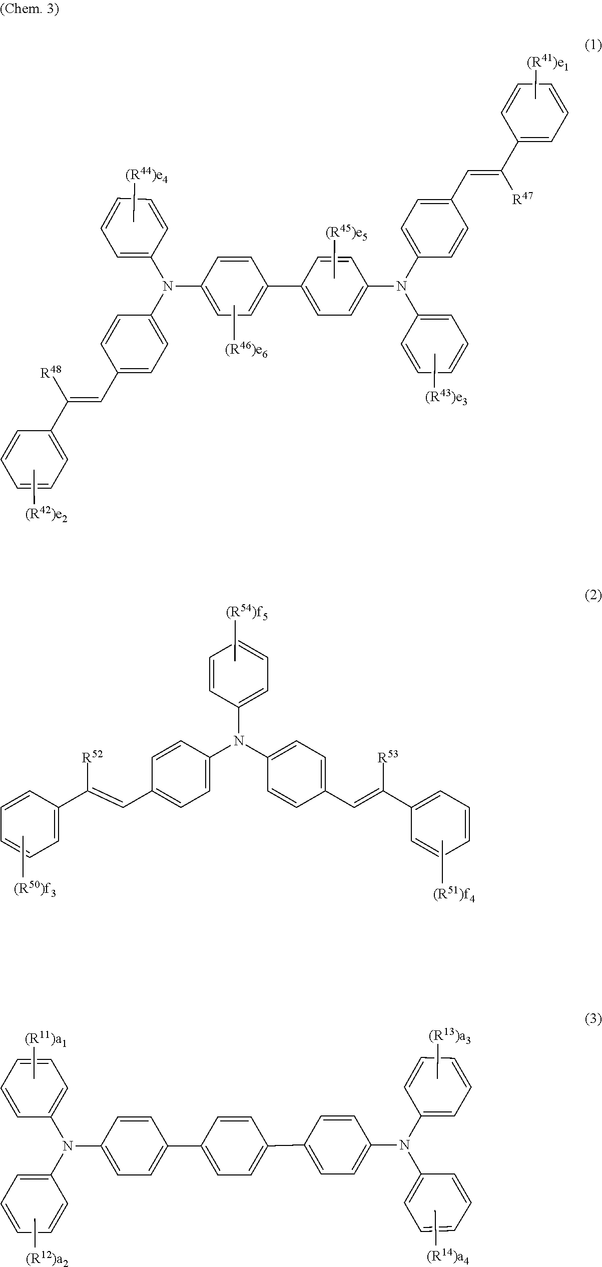

In the formula (1), R⁴¹, R⁴², R⁴³, R⁴⁴, R⁴⁵, and R⁴⁶ each independently represent an alkyl group having 1 or more and 8 or less carbon atoms or a phenyl group. R⁴⁷ and R⁴⁸ each independently represent a hydrogen atom, an alkyl group having 1 or more and 8 or less carbon atoms, or a phenyl group. e₁, e₂, e₃, and e₄ each independently represent an integer of 0 or more and 5 or less. e₅ and e₆ each independently represent an integer of 0 or more and 4 or less.

In the formula (1), when e₁ represents an integer of 2 or more and 5 or less, a plurality of R⁴¹ may represent the same group or different groups. When e₂ represents an integer of 2 or more and 5 or less, a plurality of R⁴² may represent the same group or different groups. When e₃ represents an integer of 2 or more and 5 or less, a plurality of R⁴³ may represent the same group or different groups. When e₄ represents an integer of 2 or more and 5 or less, a plurality of R⁴⁴ may represent the same group or different groups. When e₅ represents an integer of 2 or more and 4 or less, a plurality of R⁴⁵ may represent the same group or different groups. When e₆ represents an integer of 2 or more and 4 or less, a plurality of R⁴⁶ may represent the same group or different groups.

In the formula (1), R⁴¹ to R⁴⁶ each independently represent favorably an alkyl group having 1 or more and 8 or less carbon atoms, more favorably an alkyl group having 1 or more and 3 or less carbon atoms, and still more favorably a methyl group or an ethyl group. R⁴⁷ and R⁴⁸ favorably each represent a hydrogen atom. It is favorable that e₁, e₂, e₃, and e₄ each independently represent an integer of 0 or more and 2 or less, and it is more favorable that e₁ and e₂ each represent 0 and e₃ and e₄ each represent 2. e₅ and e₆ favorably each represent 0.

In the formula (2), R⁵⁰, R⁵¹, and R⁵⁴ each independently represent an alkyl group having 1 or more and 8 or less carbon atoms or a phenyl group. R⁵² and R⁵³ each independently represent a hydrogen atom, an alkyl group having 1 or more and 8 or less carbon atoms, or a phenyl group that may be substituted with an alkyl group having 1 or more and 8 or less carbon atoms. f₃, f₄, and f₅ each independently represent an integer of 0 or more and 5 or less.

In the formula (2), when f₃ represents an integer of 2 or more and 5 or less, a plurality of R⁵⁰ may represent the same group or different groups. When f₄ represents an integer of 2 or more and 5 or less, a plurality of R⁵¹ may represent the same group or different groups. When f₅ represents an integer of 2 or more and 5 or less, a plurality of R⁵⁴ may represent the same group or different groups.

In the formula (2), R⁵⁰, R⁵¹, and R⁵⁴ each independently represent favorably an alkyl group having 1 or more and 8 or less carbon atoms, more favorably an alkyl group having 1 or more and 3 or less carbon atoms, and still more favorably a methyl group. R⁵² and R⁵³ favorably each independently represent a hydrogen atom, an unsubstituted phenyl group, or a phenyl group substituted with an alkyl group having 1 or more and 8 or less carbon atoms. In the case where the phenyl group is substituted with an alkyl group having 1 or more and 8 or less carbon atoms, as such an alkyl group having 1 or more and 8 or less carbon atoms, an alkyl group having 1 or more and 3 or less carbon atoms is favorable and a methyl group is more favorable. f₃, f₄, and f₅ favorably each independently represent 0 or 1.

In the formula (3), R¹¹, R¹², R¹³, and R¹⁴ each independently represent an alkyl group having 1 or more and 8 or less carbon atoms or a phenyl group. a₁, a₂, a₃, and a₄ each independently represent an integer of 0 or more and 5 or less.

In the formula (3), when a₁ represents an integer of 2 or more and 5 or less, a plurality of R¹¹ may represent the same group or different groups. When a₂ represents an integer of 2 or more and 5 or less, a plurality of R¹² may represent the same group or different groups. When a₃ represents an integer of 2 or more and 5 or less, a plurality of R³ may represent the same group or different groups. When a₄ represents an integer of 2 or more and 5 or less, a plurality of R¹⁴ may represent the same group or different groups.

In the formula (3), R¹¹, R¹², R¹³, and R¹⁴ each independently represent favorably an alkyl group having 1 or more and 3 or less carbon atoms, more favorably a methyl group or an ethyl group. a₁, a₂, a₃, and a₄ each independently represent favorably an integer of 1 or more and 3 or less, more favorably 1.

Suitable examples of the hole transporting agent include compounds represented by the formulae (HT-2), (HT-3), and (HT-4) (hereinafter, respectively referred to as hole transporting agents (HT-2), (HT-3), and (HT-4) in some cases). The photosensitive layer favorably includes, as a hole transporting agent, one or both of the hole transporting agents (HT-2) and (HT-3).

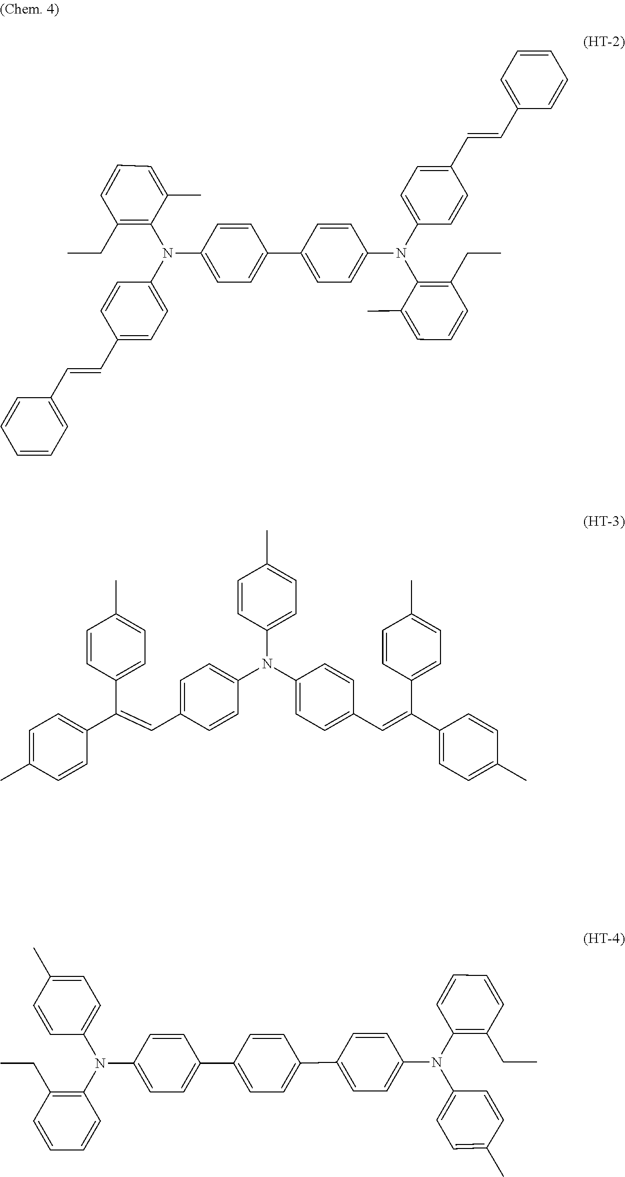

The content ratio of the hole transporting agents (1) to (3) is favorably 80 mass % or more, more favorably 90 mass % or more, and still more favorably 100 mass %, with respect to the total mass of the hole transporting agents.

In the case where ultraviolet rays are applied in the protective layer forming step, in order to suppress decomposition of the hole transporting agent due to irradiation of ultraviolet rays, the hole transporting agent favorably has two or less (one or two) chain ethene-1,2-diyl groups or no chain ethene-1,2-diyl group. Hereinafter, the “chain ethene-1,2-diyl group” will be referred to as a “predetermined double bond” in some cases. The predetermined double bond is a bond represented by the following formula (DB). In the formula (DB), * represents atomic bonding. The predetermined double bond is an unsubstituted ethene-1,2-diyl group. The predetermined double bond is a double bond forming a chain group because it is chain. The predetermined double bond is not a double bond forming a ring such as a benzene ring because it is chain.

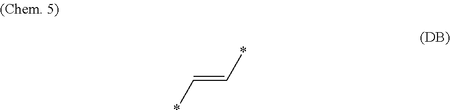 [SMILES: */C=C/*]

In the case where ultraviolet rays are applied in the protective layer forming step, in order to suppress decomposition of the hole transporting agent due to irradiation of ultraviolet rays, the content ratio of the hole transporting agent having two or less predetermined double bonds or no predetermined double bond is favorably 80 mass % or more, more favorably 90 mass % or more, and still more favorably 100 mass %, with respect to the mass of the hole transporting agent.

In the case where the photoreceptor is a single-layer photoreceptor, the content of the hole transporting agent is favorably 10 parts by mass or more and 200 parts by mass or less, more favorably 80 parts by mass or more and 130 parts by mass or less, with respect to 100 parts by mass of the binder resin.

In order to improve the sensitivity characteristics of the photoreceptor, in the case where the photoreceptor is a single-layer photoreceptor, the total content ratio of the hole transporting agent and the electron transporting agent is favorably 40 mass % or more, more favorably 40 mass % or more and 60 mass % or less, with respect to the mass of the single-layer photosensitive layer.

In the case where the photoreceptor is a stacked photoreceptor, the content of the hole transporting agent is favorably 10 parts by mass or more and 200 parts by mass or less, more favorably 50 parts by mass or more and 100 parts by mass or less, with respect to 100 parts by mass of the binder resin.

In order to improve the sensitivity characteristics of the photoreceptor, in the case where the photoreceptor is a stacked photoreceptor, the content ratio of the hole transporting agent is favorably 40.0 mass % or more, more favorably 40.0 mass % or more and 60.0 mass % or less, with respect to the mass of the charge transporting layer.

Examples of the electron transporting agent include a quinone compound, a diimide compound, a hydrazone compound, a malononitrile compound, a thiopyran compound, a trinitrothioxanthone compound, a 3,4,5,7-tetranitro-9-fluorenone compound, a dinitroanthracene compound, a dinitroacridine compound, tetracyanoethylene, 2,4,8-trinitrothioxanthone, dinitrobenzene, dinitroacridine, succinic anhydride, maleic anhydride, and dibromomaleic anhydride. Examples of the quinone compound include a diphenoquinone compound, an azoquinone compound, an anthraquinone compound, a naphthoquinone compound, a nitroanthraquinone compound, and a dinitroanthraquinone compound.

The electron transporting agent favorably includes at least one of compounds represented by the formulae (11), (12), (13), (14), (15), and (16). Hereinafter, the compounds represented by the formulae (11), (12), (13), (14), (15), and (16) will be respectively referred to as electron transporting agents (11), (12), (13), (14), (15), and (16) in some cases.

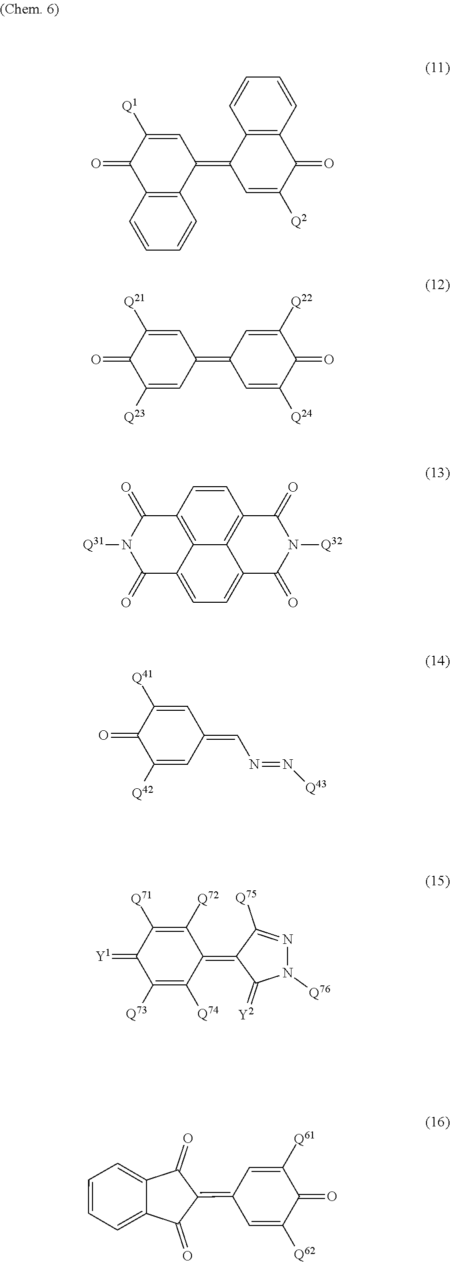

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least one substituent group one selected from the group consisting of an alkyl group having 1 or more and 6 or less carbon atoms and a halogen atom. Y¹ and Y² in the formula (15) each represent an oxygen atom.

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16) favorably each independently represent a hydrogen atom, an alkyl group having 1 or more and 6 or less carbon atoms, or an aryl group having 6 or more and 14 or less carbon atoms that may be substituted with at least one substituent group one selected from the group consisting of an alkyl group having 1 or more and 6 or less carbon atoms and a halogen atom.

As the alkyl group having 1 or more and 6 or less carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16), an alkyl group having 1 or more and 5 or less carbon atoms is favorably, a methyl group, an ethyl group, a propyl group, a butyl group, or a pentyl group is favorable, a methyl group, a tert-butyl group, or a 1,1-dimethylpropyl group is particularly favorable.

As the aryl group having 6 or more and 14 or less carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16), an aryl group having 6 or more and 10 or less carbon atoms is favorable and a phenyl group is more favorable. The aryl group having 6 or more and 14 or less carbon atoms may be substituted with at least one substituent group selected from the group consisting of an alkyl group having 1 or more and 6 or less carbon atoms and a halogen atom. As such an alkyl group having 1 or more and 6 or less carbon atoms, an alkyl group having 1 or more and 3 or less carbon atoms is favorable and a methyl group or an ethyl group is more favorable. As the halogen atom that is a substituent group, a fluorine atom, a chlorine atom, or a bromine atom is favorable and a chlorine atom is particularly favorable. In the case where the aryl group having 6 or more and 14 or less carbon atoms is substituted with a substituent group, the number of substituent groups is favorably 1 or more and 5 or less, more favorably 1 or 2. As the aryl group having 6 or more and 14 or less carbon atoms substituted with at least one substituent group selected from the group consisting of an alkyl group having 1 or more and 6 or less carbon atoms and a halogen atom, a chlorophenyl group, a dichlorophenyl group, or an ethylmethylphenyl group is favorable and a 4-chlorophenyl group, a 2,5-dichlorophenyl group, or a 2-ethyl-6-methylphenyl group is more favorable.

Suitable examples of the electron transporting agent include compounds represented by the formulae (ET-1) to (ET-7) (hereinafter, respectively referred to as electron transporting agents (ET-1) to (ET-7) in some cases).

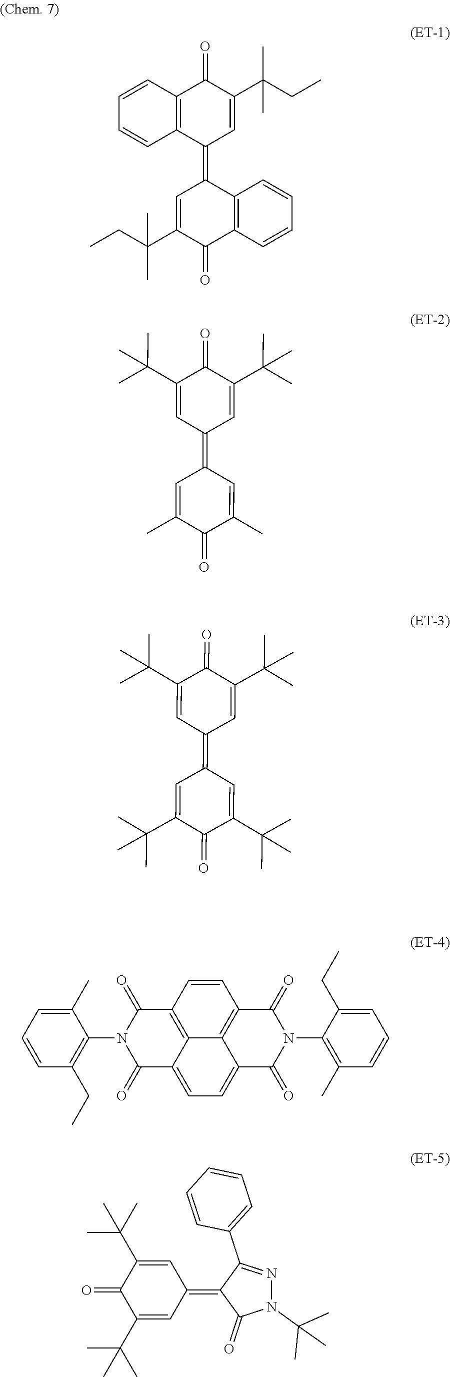

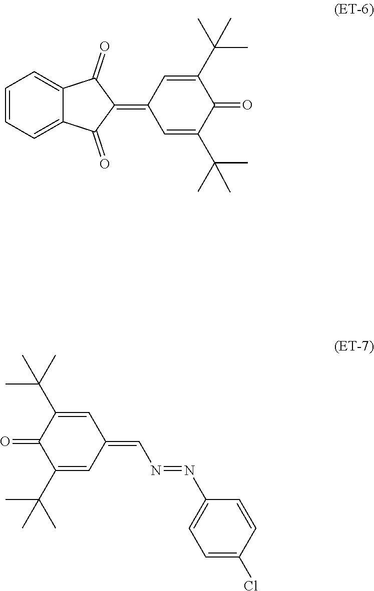

The content ratio of the electron transporting agents (11) to (16) is favorably 80 mass % or more, more favorably 90 mass % or more, and still more favorably 100 mass %, with respect to the mass of the electron transporting agent.

In the case where the photoreceptor is a single-layer photoreceptor, the content of the electron transporting agent is favorably 5 parts by mass or more and 150 parts by mass or less, more favorably 10 parts by mass or more and 50 parts by mass or less, with respect to 100 parts by mass of the binder resin.

Examples of the binder resin include a thermoplastic resin (more specifically, a polyarylate resin, a polycarbonate resin, a styrene resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallylphthalate resin, a ketone resin, a polyvinylbutyral resin, a polyvinylacetal resin, and a polyether resin), a thermosetting resin (more specifically, a silicone resin, an epoxy resin, a phenolic resin, a urea resin, a melamine resin, and a cross-linkable thermosetting resin other than these), and a photocurable resin (more specifically, an epoxy-acrylic acid resin and a urethane-acrylic acid copolymer).

Of these resins, a polycarbonate resin is favorable because a single-layer photosensitive layer and a charge transporting layer having an excellent balance of workability, mechanical strength, optical characteristics, and wear resistance can be obtained. Examples of the polycarbonate resin include a bisphenol Z-type polycarbonate resin, a bisphenol B-type polycarbonate resin, a bisphenol ZC-type polycarbonate resin, a bisphenol C-type polycarbonate resin, and a bisphenol A-type polycarbonate resin. As the binder resin, a bisphenol Z-type polycarbonate resin or a bisphenol B-type polycarbonate resin is favorable. The bisphenol Z-type polycarbonate resin is a resin including a repeating unit represented by the formula (BisZ). The bisphenol B-type polycarbonate resin is a resin including a repeating unit represented by the formula (BisB).

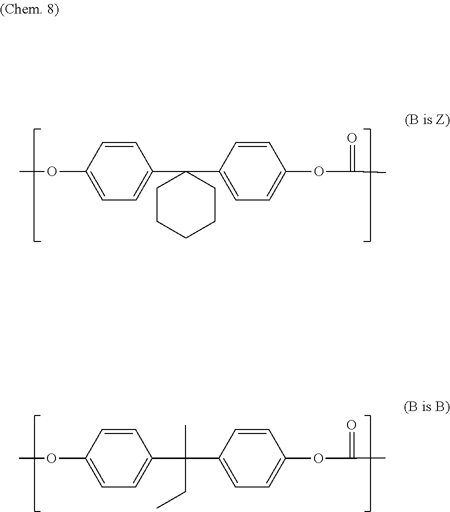

Examples of the base resin included in the charge generating layer are the same as the examples of the binder resin included in the charge transporting layer. However, in order to suitably form a charge generating layer and a charge transporting layer, it is favorable to select, as a base resin, a resin different from the resin used as the binder resin, of the above examples of the binder resin. The base resin is, for example, a polyvinylacetal resin.

Examples of the additive included in the photosensitive layer include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent. Examples of the leveling agent include silicone oil, more specifically, dimethylsilicone oil.

### [Intermediate Layer]

The presence of the intermediate layer makes the flow of currents generated when the photoreceptor is exposed smooth and makes it possible to suppress an increase in resistance, while maintaining the insulated state to the extent that leakage can be suppressed. The intermediate layer (undercoat layer) includes, for example, one or both of an inorganic particle and an organic particle, and a resin used for the intermediate layer (intermediate layer resin). Hereinafter, the inorganic particle and the organic particle included in the intermediate layer will be collectively referred to as an intermediate layer particle. The ratio of the mass of the intermediate layer particle with respect to the mass of the intermediate layer resin is, for example, 1 or more and 4 or less. The thickness of the intermediate layer is, for example, 0.1 μm or more and 5 μm or less.

Examples of the inorganic particle of the intermediate layer particle include a white pigment (more specifically, titanium oxide, zinc oxide, zinc flower, zinc sulfide, white lead, lithopone, and the like), and an extender pigment (more specifically, alumina, calcium carbonate, barium sulfate, and the like). Examples of the organic particle of the intermediate layer particle include a fluoropolymer particle, a benzoguanamine resin particle, and a styrene resin particle. The number average primary particle size of the intermediate layer particle is favorably 100 nm or less, more favorably 1 nm or more and 50 nm or less. As the intermediate layer particle, an inorganic particle is favorable and titanium oxide is more favorable. Titanium oxide may be subjected to surface treatment. The surface treatment of titanium oxide may be performed once or a plurality of times (e.g., twice). Examples of the surface treatment agent used for the surface treatment of titanium oxide include alumina, silica, and an organosilicon compound (e.g., polysiloxane, more specifically, methylhydrogenpolysiloxane).

Examples of the intermediate layer resin are the same as the examples of the binder resin included in the photosensitive layer. However, in order to suitably form a photosensitive layer, it is favorable to select, as an intermediate layer resin, a resin different from the resin used as the binder resin, of the above examples of the binder resin. The intermediate layer resin is, for example, a polyamide resin.

### [Conductive Base]

The conductive base is not particularly limited, and at least the surface portion thereof only needs to be formed of a material having conductivity. One example of the conductive base is a conductive base formed of a material having conductivity. Another example of the conductive base is a conductive base covered with a material having conductivity. Examples of the material having conductivity include aluminum, iron, copper, tin, platinum, silver, vanadium, molybdenum, chromium, cadmium, titanium, nickel, palladium, and indium. Two or more materials having conductivity may be combined and used as an alloy (more specifically, an aluminum alloy, stainless steel, brass, or the like). As the material having conductivity, aluminum and an aluminum alloy are favorable because they provide good charge transfer from the photosensitive layer to the conductive base. The shape of the conductive base is appropriately selected in accordance with the structure of the image forming apparatus. Examples of the shape of the conductive base include a sheet shape and a drum shape. Further, the thickness of the conductive base is appropriately selected in accordance with the shape of the conductive base.

### Examples and Comparative Examples

As Examples and Comparative Examples of the present disclosure, photoreceptors were prepared and evaluated. Note that the following Examples are merely illustrative examples of the present disclosure, and the present disclosure is not limited to the configurations of the following Examples.

### (Preparation of Stacked Photoreceptor)

2 parts by mass of titanium oxide that has been subjected to surface treatment with alumina and silica and then surface treatment with methylhydrogenpolysiloxane while wet dispersing (“SMT-A” manufactured by TAYCA Co., Ltd., number average primary particle size of 10 nm), 1 part by mass of a quaternary copolymerized polyamide resin (“Amilan CM8000” manufactured by TORAY INDUSTRIES, INC.), 10 parts by mass of methanol, 1 part by mass of butanol, and 1 part by mass of toluene were dispersed for 5 hours using a bead mill, thereby preparing a coating liquid for an intermediate layer. The obtained coating liquid for an intermediate layer was filtered using a 5 μm filter and then applied to an aluminum drum-shaped support having a diameter of 30 mm as a conductive support by a dip coating method, and heat treatment was performed thereon at 130° C. for 30 minutes to form an intermediate layer having a film thickness of 0.5 μm.

Next, 1.5 parts by mass of a Y-type titanyl phthalocyanine, 1 part by mass of a polyvinylacetal resin (S-LEC BX-5 manufactured by SEKISUI CHEMICAL CO., LTD.) as a binder resin, 40 parts by mass of propylene glycol monomethyl ether as a dispersion medium, and 40 parts by mass of tetrahydrofuran were mixed and dispersed for 12 hours using a bead mill, thereby preparing a coating liquid for a charge generating layer. The obtained coating liquid was filtered using a 3 μm filter, then applied onto the intermediate layer prepared above by a dip coating method, and dried at 50° C. for 5 minutes to form a charge generating layer having a predetermined film thickness.

Next, 100 parts by mass of a hole transporting agent represented by the formula (HTM-1), 100 parts by mass of a polycarbonate resin as a binder resin, various pigments, 0.05 parts by mass of dimethylsilicone oil KF96-50CS as a leveling agent, 340 parts by mass of tetrahydrofuran as a solvent, and 60 parts by mass of toluene were mixed to prepare a coating liquid for a charge transporting layer. The prepared coating liquid for a charge transporting layer was applied onto the charge generating layer and dried at 120° C. for 40 minutes to form a charge transporting layer having a film thickness of 25 μm.

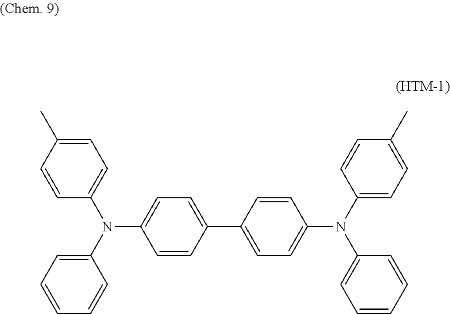 [SMILES: Cc1ccc(N(c2ccccc2)c2ccc(-c3ccc(N(c4ccccc4)c4ccc(C)cc4)cc3)cc2)cc1]

Next, 9.2 parts by mass of antimony-doped tin oxide, 3.5 parts by mass of alumina, a first acrylic monomer (“A-DPH” manufactured by SHIN-NAKAMURA CHEMICAL CO, LTD.), a second acrylic monomer (“Viscoat-8F” manufactured by OSAKA ORGANIC CHEMICAL INDUSTRY LTD.), a leveling agent(“8FS-001” manufactured by OSAKA ORGANIC CHEMICAL INDUSTRY LTD.), an oxygen absorber, a photopolymerization initiator, and 110 parts by mass of methanol were mixed and dispersed for 12 hours using a bead mill, thereby preparing a coating liquid for a protective layer. The obtained coating liquid was filtered using a 5 μm filter, then applied onto the charge transporting layer by a dip coating method, and deposited by light irradiation to form a protective layer having a film thickness of 2.0 μm, thereby preparing a stacked electrophotographic photoreceptor. At this time, for checking the quality of the prepared coating liquid, the coating liquid was applied onto an aluminum drum-shaped support having a diameter of 30 mm by a dip coating method and deposited by light irradiation, thereby preparing a protective layer having a film thickness of 3.0 μm.

### (Preparation of Stacked Photoreceptor)

2 parts by mass of titanium oxide that has been subjected to surface treatment with alumina and silica and then surface treatment with methylhydrogenpolysiloxane while wet dispersing (“SMT-A” manufactured by TAYCA Co., Ltd., a number average primary particle size of 10 nm), 1 part by mass of a quaternary copolymerized polyamide resin (“Amilan CM8000” manufactured by TORAY INDUSTRIES, INC.), 10 parts by mass of methanol, 1 part by mass of butanol, and 1 part by mass of toluene were dispersed for 5 hours using a bead mill, thereby preparing a coating liquid for an intermediate layer. The obtained coating liquid for an intermediate layer was filtered using a 5 μm filter and then applied to an aluminum drum-shaped support having a diameter of 30 mm as a conductive support by a dip coating method, and heat treatment was performed thereon at 130° C. for 30 minutes to form an intermediate layer having a film thickness of 0.5 μm.

Next, 2.85 parts by mass of a Y-type titanyl phthalocyanine, 60 parts by mass of a hole transporting agent represented by the formula (HTM-2), 30 parts by mass of a hole transporting agent represented by the formula (HTM-3), 33.5 parts by mass of an electron transporting agent represented by the formula (ETM-1), 33.5 parts by mass of an electron transporting agent represented by the formula (ETM-2), 138 parts by mass of a polycarbonate resin as a binder resin, 0.02 parts by mass of dimethylsilicone oil KF96-50CS as a leveling agent, and 500 parts by mass of tetrahydrofuran as a solvent were mixed and dispersed for 20 minutes using a rod-shaped sonic oscillator, thereby forming a coating liquid for a photosensitive layer. The obtained coating liquid was filtered using a 5 μm filter, then applied onto an aluminum drum-shaped support having a diameter of 30 mm as a conductive support by a dip coating method, and dried at 0° C. for 60 minutes by a dip coating method, thereby forming a photosensitive layer having a film thickness of 25 μm.

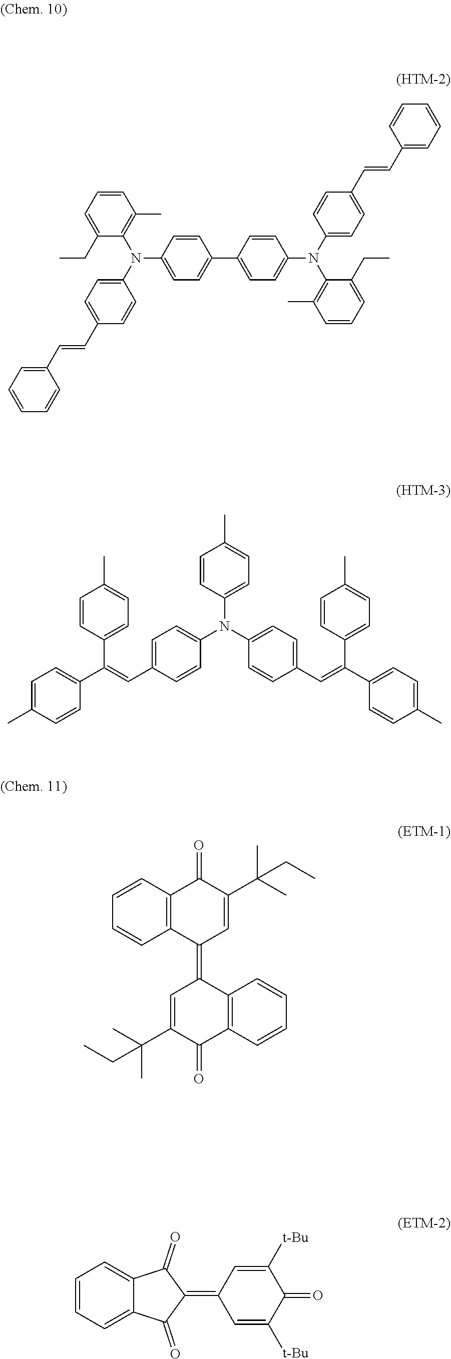

Next, 9.2 parts by mass of antimony-doped tin oxide, 3.5 parts by mass of alumina, a first acrylic monomer (“A-DPH” manufactured by SHIN-NAKAMURA CHEMICAL CO, LTD.), a second acrylic monomer (“Viscoat-8F” manufactured by OSAKA ORGANIC CHEMICAL INDUSTRY LTD.), a leveling agent (“8FS-001” manufactured by OSAKA ORGANIC CHEMICAL INDUSTRY LTD.), an oxygen absorber, a photopolymerization initiator, and 110 parts by mass of methanol were mixed and dispersed for 12 hours using a bead mill, thereby preparing a coating liquid for a protective layer. The obtained coating liquid was filtered using a 5 μm filter, then applied onto the charge transporting layer by a dip coating method, and deposited by light irradiation to form a protective layer having a film thickness of 2.0 μm, thereby preparing a stacked electrophotographic photoreceptor. At this time, for checking the quality of the prepared coating liquid, the coating liquid was applied onto an aluminum drum-shaped support having a diameter of 30 mm by a dip coating method and deposited by light irradiation, thereby preparing a protective layer having a film thickness of 3.0 μm.

### (Measurement of Degree of Curing of Protective Layer)

The degree of curing of the protective layer was measured by peeling off the protective layer at the center position of the photoreceptor and measuring both surfaces (the front surface side and the photosensitive layer side (inner side)) of the peeled protective layer. Specifically, the infrared absorption spectrum of each surface of the protective layer was measured using a Fourier transformation infrared spectrometer (manufactured by PerkinElmer, inc., a product name “SpectrumOne”). The measurement was performed in the range of 4000 cm-1 to 650 cm-1, and a height A of the maximum absorption peak in the range of 1400 to 1420 cm-1 and a height B of the maximum absorption peak in the range of 1600 to 1950 cm-1 were obtained. Similarly, for the protective layer (photocurable composition) before curing, a height C of the maximum absorption peak in the range of 1400 to 1420 cm-1 and a height D of the maximum absorption peak in the range of 1600 to 1950 cm-1 were obtained. In the infrared absorption spectrum, the degree of curing of each of the surface and inside of the protective layer was obtained using the following formula, Ab indicating the baseline value of the maximum absorption peak corresponding to the height A, Bb indicating the baseline value of the maximum absorption peak corresponding to the height B, Cb indicating the baseline value of the maximum absorption peak corresponding to the height C, and Db indicating the baseline value of the maximum absorption peak corresponding to the height D.

$$The degree of curing = [ 1 - \{ ( Ab - A ) / ( Bb - B ) \} / \{ ( C b - C ) / ( Db - D ) \} ] \times 100$$

### (Evaluation of Image Deletion)

A modified machine obtained by adjusting a color printer (“Taskalfa 356ci” manufactured by KYOCERA Document Solutions Inc.) for negative charge evaluation was used as an evaluation device. The toner cartridge of the evaluation device was filled with a cyan toner. First, the photoreceptor was mounted on the evaluation device. Subsequently, a low-density image (pattern image with a coverage rate of 1.6%) was printed on 10000 sheets of paper in a high-temperature and high-humidity environment (a temperature of 32° C. and a relative humidity of 80% RH: hereinafter, referred to as an HH environment in some cases) using the evaluation device, and the 10000th image was used as an evaluation image. As the evaluation of image deletion, 1-dot reproducibility of the evaluation image was evaluated in accordance with the following criteria A, B, and C. Photoreceptors with the evaluation of A for image deletion are evaluated to “Pass”, and photoreceptors with the evaluation of B or C are evaluated to “Fail”.
A: One dot has been completely reproduced.
B: More than half of one dot has been reproduced.
C: One dot has disappeared.

### (Photopolymerization Initiator and Oxygen Absorber)

In the photoreceptors according to Examples and Comparative Examples, compounds represented by the formulae (P-1) to (P-5) were used as photopolymerization initiators in the protective layer. The compounds represented by the formula (P-1) and the formula (P-2) correspond to the first compound having an acylphosphine oxide structure. The compounds represented by the formula (P-3) and the formula (P-4) correspond to the second compound having an α-aminoacetophenone structure. The compound represented by the formula (P-5) is a compound having an α-hydroxyacetophenone structure.

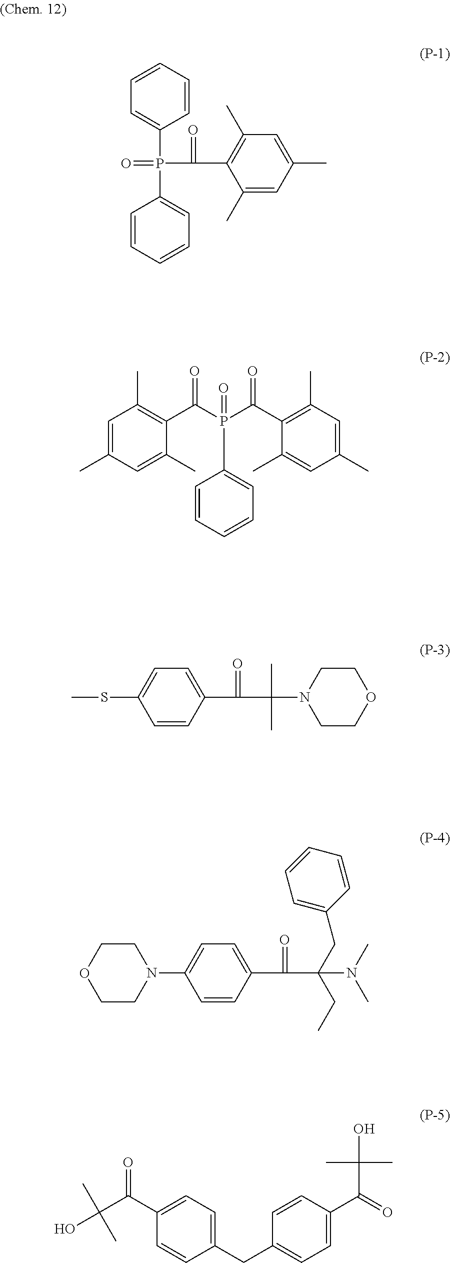

Further, in the photoreceptors according to Examples and Comparative Examples, a compound represented by the formula (ADD-1) was used as an oxygen absorber of the protective layer.

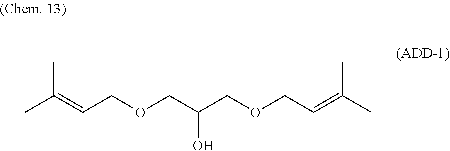 [SMILES: CC(C)=CCOCC(O)COCC=C(C)C]

### Examples 1 to 18

In the photo receptors according to Examples 1 to 18, the type of photosensitive layer, the type and amount of photopolymerization initiator, and the content of the oxygen absorber were varied. Table shows the type of photosensitive layer, the type and amount of the first compound and the second compound constituting the photopolymerization initiator, and the content of the oxygen absorber for the photoreceptors according to Examples 1 to 18. All of the photoreceptors according to Examples 1 to 18 have the configuration of the photoreceptor according to the above embodiment.

TABLE 1

| | | Photopolymerization initiator | | | | | Oxygen |
|---|---|---|---|---|---|---|---|
| | | First compound | | Second compound | | Total | absorber |
| | Photosensitive | | Parts | | Parts | parts | Parts |
| Example | layer | Type | by mass | Type | by mass | by mass | by mass |
| 1 | Stacked | P-1 | 5 | P-3 | 5 | 10 | 1 |
| 2 | Stacked | P-1 | 2 | P-3 | 8 | 10 | 1 |
| 3 | Stacked | P-1 | 4 | P-3 | 6 | 10 | 1 |
| 4 | Stacked | P-1 | 6 | P-3 | 4 | 10 | 1 |
| 5 | Stacked | P-1 | 8 | P-3 | 2 | 10 | 1 |
| 6 | Stacked | P-1 | 2.5 | P-3 | 2.5 | 5 | 1 |
| 7 | Stacked | P-1 | 10 | P-3 | 10 | 20 | 1 |
| 8 | Stacked | P-2 | 5 | P-3 | 5 | 10 | 1 |
| 9 | Stacked | P-2 | 2 | P-3 | 8 | 10 | 1 |
| 10 | Stacked | P-2 | 4 | P-3 | 6 | 10 | 1 |
| 11 | Stacked | P-2 | 6 | P-3 | 4 | 10 | 1 |
| 12 | Stacked | P-2 | 8 | P-3 | 2 | 10 | 1 |
| 13 | Stacked | P-2 | 2.5 | P-3 | 2.5 | 5 | 1 |
| 14 | Stacked | P-2 | 10 | P-3 | 10 | 20 | 1 |
| 15 | Single-layer | P-2 | 5 | P-3 | 5 | 10 | 1 |
| 16 | Stacked | P-1 | 5 | P-3 | 5 | 10 | 0 |
| 17 | Stacked | P-1 | 5 | P-3 | 5 | 10 | 0.5 |
| 18 | Stacked | P-1 | 5 | P-3 | 5 | 10 | 10 |

Table 2 shows the measurement results of the degree of curing of the surface and inside of the protective layer and the evaluation results of image deletion for the photoreceptors according to Examples 1 to 18. All of the photoreceptors according to Examples 1 to 18 obtained a high degree of curing of the surface and inside of the protective layer and were evaluated to “Pass” for image deletion. Further, when comparing Examples 1 and 16 to 18 in which only the content of the oxygen absorber differs, the degree of curing of the surface and inside of the protective layer was higher in Examples 1, 17, and 18 in which the content of the oxygen absorber is 0.1 mass % or more and 10 mass % or less than Example 16 in which no oxygen absorber is blended.

TABLE 2

| | Degree of curing | | Image |
|---|---|---|---|
| Example | Surface | Inside | deletion |
| 1 | 75.6 | 76.1 | A |
| 2 | 72.3 | 68.7 | A |
| 3 | 70.7 | 70.3 | A |
| 4 | 70.2 | 71.4 | A |
| 5 | 66.7 | 73.5 | A |
| 6 | 64.8 | 70.0 | A |
| 7 | 70.6 | 63.9 | A |
| 8 | 78.2 | 77.9 | A |
| 9 | 73.4 | 69.3 | A |
| 10 | 72.1 | 71.5 | A |
| 11 | 71.2 | 73.0 | A |
| 12 | 68.2 | 73.3 | A |
| 13 | 64.5 | 70.4 | A |
| 14 | 63.4 | 69.7 | A |
| 15 | 77.5 | 76.7 | A |
| 16 | 66.2 | 67.1 | A |
| 17 | 75.1 | 75.3 | A |
| 18 | 72.4 | 72.8 | A |

### Comparative Examples 1 to 11

Table 3 shows the type of photosensitive layer, the type and amount of the first compound and the second compound constituting the photopolymerization initiator, and the content of the oxygen absorber for the photoreceptors according to Comparative Examples 1 to 11. The photoreceptors according to Comparative Examples 1, 2, and 7 are different from the photoreceptor according to the above Example in that the protective layer does not include a second compound. The photoreceptor according to Comparative Example 3 is different from the photoreceptor according to the above Example in that the protective layer does not include a first compound. The photoreceptor according to Comparative Example 4 is different from the photoreceptor according to the above Example in that the total content of the first compound and the second compound with respect to 100 parts by mass of the photocurable composition is less than 10 parts by mass. The photoreceptors according to Comparative Examples 5 and 6 are different from the photoreceptor according to the above Example in that the total content of the first compound and the second compound with respect to 100 parts by mass of the photocurable composition exceeds 20 parts by mass. The photoreceptors according to Comparative Examples 8 and 10 are different from the photoreceptor according to the above Example in that the second compound has an absorption coefficient at a wavelength 365 nm larger than that of the first compound. The photoreceptor according to Comparative Example 9 is different from the photoreceptor according to the above Example in that the protective layer does not include a second compound but include a compound represented by the formula (P-5) instead of the second compound.

TABLE 3

| | | Photopolymerization initiator | | | | | Oxygen |
|---|---|---|---|---|---|---|---|
| | | First compound | | Second compound | | Total | absorber |
| Comparative | Photosensitive | | Parts | | Parts | parts | Parts |
| Example | layer | Type | by mass | Type | by mass | by mass | by mass |
| 1 | Stacked | P-1 | 10 | — | — | 10 | 1 |
| 2 | Stacked | P-2 | 10 | — | — | 10 | 1 |
| 3 | Stacked | — | — | P-3 | 10 | 10 | 1 |
| 4 | Stacked | P-1 | 2 | P-3 | 2 | 4 | 1 |
| 5 | Stacked | P-1 | 11 | P-3 | 11 | 22 | 1 |
| 6 | Stacked | P-1 | 13 | P-3 | 13 | 26 | 1 |
| 7 | Stacked | P-1 | 5 | — | — | 10 | 1 |
| | | P-2 | 5 | | | | |
| 8 | Stacked | P-1 | 5 | P-4 | 5 | 10 | 1 |
| 9 | Stacked | P-1 | 5 | * | * | 5 | 1 |
| 10 | Stacked | P-2 | 5 | P-4 | 5 | 10 | 1 |

*5 parts by mass of the compound represented by the formula (P-5) is blended instead of the second compound

Table 4 shows the measurement results of the degree of curing of the surface and inside of the protective layer and the evaluation results of image deletion for the photoreceptors according to Comparative Examples 1 to 11. All of the photoreceptors according to Comparative Examples 1 to 11 were evaluated to “Fail” for image deletion. This is presumably because for the photoreceptors according to Comparative Examples 1, 2, and 7 in which the protective layer does not include a second compound, the degree of curing of the surface of the protective layer was insufficient. This is presumably because for the photoreceptor according to Comparative Example 3 in which the protective layer does not include a first compound, the degree of curing of the inside of the protective layer was insufficient. This is presumably because for the photoreceptor according to Comparative Example 4 in which the total content of the first compound and the second compound is small, the degree of curing of both the surface and inside of the protective layer was insufficient. This is presumably because of the influence of the excess photopolymerization initiator for the photoreceptors according to Comparative Examples 5 and 6 in which the total content of the first compound and the second compound is large. This is presumably because for the photoreceptors according to Comparative Examples 8 and 10 in which the second compound has an absorption coefficient at a wavelength 365 nm larger than that of the first compound, the rapid curing of the surface in the protective layer prevented the inside from being cured sufficiently. This is presumably because for the photoreceptor according to Comparative Example 9 in which the compound represented by the formula (P-5) was blended instead of the second compound, the effect of promoting the curing reaction of the photocurable compound on the surface of the protective layer by the second compound was not achieved.

TABLE 4

| | | |
|---|---|---|
| Comparative | Degree of curing | Image |

| Example | Surface | Inside | deletion |
|---|---|---|---|
| 1 | 42.8 | 66.4 | B |
| 2 | 44.3 | 67.7 | B |
| 3 | 69.9 | 42.1 | C |
| 4 | 55.7 | 40.2 | C |
| 5 | 68.9 | 59.3 | B |
| 6 | 69.1 | 56.7 | C |
| 7 | 58.6 | 73.6 | B |
| 8 | 66.9 | 59.4 | C |
| 9 | 54.8 | 65.2 | C |
| 10 | 67.3 | 59.3 | B |

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photoreceptor, comprising:
a conductive base;
a photosensitive layer provided on the conductive base; and
a protective layer provided on the photosensitive layer,
the protective layer being a cured body of a photocurable composition that includes a photocurable compound and a photopolymerization initiator,
the photopolymerization initiator including a first compound having an acylphosphine oxide structure and a second compound having an α-aminoacetophenone structure and an absorption coefficient at a wavelength 365 nm smaller than that of the first compound,
a total content of the first compound and the second compound with respect to 100 parts by mass of the photocurable compound being 5 parts by mass or more and 20 parts by mass or less.

2. The electrophotographic photoreceptor according to claim 1, wherein
the photocurable compound includes two or more types of monomers and/or oligomers having an acryloyl group.

3. The electrophotographic photoreceptor according to claim 1, wherein
the photocurable compound includes a compound having three or more polymerizable functional groups and a compound having two or less polymerizable functional groups.

4. The electrophotographic photoreceptor according to claim 1, wherein
the photocurable composition further includes an oxygen absorber.

5. The electrophotographic photoreceptor according to claim 4, wherein
the oxygen absorber includes a compound represented by the following formula (A): 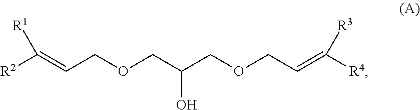
in the formula (A), R¹ to R⁴ each independently represent either one of an alkyl group having 1 to 6 carbon atoms, an alkenyl group having 2 to 6 carbon atoms, and an aralkyl group.

6. The electrophotographic photoreceptor according to claim 4, wherein
a content of the oxygen absorber in the protective layer is 0.1 mass % or more and 10 mass % or less.

7. The electrophotographic photoreceptor according to claim 4, wherein
the protective layer is a cured body obtained by curing the photocurable composition by irradiation of ultraviolet light in an atmospheric atmosphere.

8. The electrophotographic photoreceptor according to claim 1, wherein
the photosensitive layer includes a charge generating agent, an electron transporting agent, and a hole transporting agent in the same layer.

9. The electrophotographic photoreceptor according to claim 1, wherein
the photosensitive layer includes a charge generating layer and a charge transporting layer, the charge generating layer including a charge generating agent, the charge transporting layer including a hole transporting agent.
